(19) United States
(12) Patent Application Publication
(10) Pub. No.: US 2022/0128291 A1
(43) Pub. Date: Apr. 28, 2022

(54) ARTIFICIAL INTELLIGENCE (AI) REFRIGERATOR

(71) Applicant: Mama Gaia Smart Fridge Corporation dba Mama Gaia, Denver, CO (US)

(72) Inventors: Sarah Lynch, Denver, CO (US); Giovanni Sudiro, Westminster, CO (US)

(73) Assignee: Mama Gaia Smart Fridge Corporation dba Mama Gaia, Denver, CO (US)

(21) Appl. No.: 17/496,090

(22) Filed: Oct. 7, 2021

Related U.S. Application Data
(60) Provisional application No. 63/105,054, filed on Oct. 23, 2020.

(51) Int. Cl. F25D 23/02; G06Q 20/20; G06Q 20/10; G06Q 10/08; G06K 9/00; G06T 7/70; G06N 20/00

(52) U.S. Cl. CPC F25D 23/028; G06Q 20/203; G06Q 20/208; G06Q 20/102; G06Q 10/087; G06T 2207/30232; G06T 7/70; G06N 20/00; F25D 2500/06; F25D 2700/06; G06K 9/00771

(57) ABSTRACT

A system is described herein that includes a smart or an artificial intelligence (AI) refrigerator for use in retail, a server, and a computing device associated with a customer. The server utilizes one or more computer vision or artificial intelligence means to control the AI refrigerator.

### CROSS-REFERENCE TO RELATED APPLICATIONS SECTION

This application is a U.S. Non-Provisional patent application that claims priority to U.S. Provisional Patent Application Ser. No. filed on 63/105,054 filed on Oct. 23, 2020, the entire contents of which are hereby incorporated by reference in their entirety.

### FIELD OF THE EMBODIMENTS

The field of the invention and its embodiments relate to an artificial intelligence (AI) refrigerator for use in retail.

### BACKGROUND OF THE EMBODIMENTS

Currently, an increasing number of devices are connected to the Internet. Some such devices are smart devices, which are electronic devices generally connected to other devices or networks via different wireless protocols, such as Bluetooth, Zigbee, NFC, Wi-Fi, LiFi, 5G, etc.

Smart devices, including clocks, speakers, lights, doorbells, windows, window blinds, and appliances, among others, are continuously being used in the home to make everyday tasks easier. Of those appliances, smart refrigerators have gained recent popularity. A smart refrigerator is a programmed refrigerator that is able to: detect the type of food items stored in it and keep track of important details about such food items, such as expiration dates of the food items and typical usages of the food items by the consumer. The processor of some smart refrigerators uses one or more cameras located inside of the refrigerator to determine which products are being stored. Moreover, some smart refrigerators are capable of automatically ordering food products when supplies of these products are low. However, such refrigerators are designed for a home environment. Thus, a need exists for an improved artificial intelligence (AI) refrigerator for use in a retail setting.

### Examples of Related Art Include

WO 2020/111961 A1 relates to an intelligent refrigerator that comprises a set of side shelves arranged in a door. A strain gauge is arranged under each side shelf and is capable of determining the weight of the shelves and of directing the measurement results to a commutation controller. A set of video cameras is incorporated into a side panel of the housing from inside and into a top panel. The video cameras are capable of producing video images and of directing the latter to a master controller. The commutation controller is incorporated on the reverse side of an interior front panel of the door and is capable of receiving data from the strain gauges and of relaying the data to the master controller. A set of rotary shelves are arranged in the main compartment of the housing. The rotary shelves are capable of rotating upon receiving a signal from the commutation controller. The commutation controller is capable of making a video recording of the contents of the refrigerator by means of the installed cameras when the door is closed to a specified angle of rotation. The technical result is an increase in the accuracy of determining the physical properties of products and goods situated in the refrigerator.

KR 1020200043316 A and TW 201437582 A describe a system for managing food in a refrigerator. A barcode or a QR code is attached to a package of food. The barcode or QR code is read by a reader or a smartphone. RFID/NFC/Bluetooth smart tags with a sensing function are attached to a bottom side, a tray, and a container box in the refrigerator. The system for managing the foods in a refrigerator automatically finds an appropriate location for the foods by comparing the barcode, the QR code, and smart tag information, and obtains information from the barcode, the QR code, and the smart tag every time a user consumes and stores the foods. The system automatically notifies the user of an estimated date for purchasing food.

KR 1020170069105 A relates to a refrigerator. The refrigerator has a barcode and QR code scanner configured such that a scanner recognizes a barcode and a QR code attached to the outside of the refrigerator. The barcode and QR code scanner recognizes the barcode and the QR code of a product, identifies information from the barcode and the QR code (such as an expiration date, a date of manufacture, and a safe storage period), and inputs the quantity and the location inside the refrigerator. The reference prevents the user from unnecessarily purchasing a product despite having the proper amount of product stored in the refrigerator.

U.S. Pat. No. 7,784,689 B2 describes a method and system for vending products from a defined area, such as a micro-warehouse with a door. The method includes fitting each product with a radio frequency identification tag, positioning the plurality of products in the micro-warehouse, sensing opening and closing of the micro-warehouse door, scanning the plurality of products in the micro-warehouse upon sensing closing of the door to determine the number and type of products in the micro-warehouse, generating a message based on the number and type of products in the micro-warehouse, transmitting the message to a remote processor or server, and maintaining an inventory in the remote processor based on the message. The micro-warehouse may be cabinets, refrigerators, secured rooms, or similar storage units or areas.

CN 209960831 U describes an embedded refrigerator with an artificial intelligence (AI) artificial intelligence control function.

WO 2019/139457 A2 describes an AI refrigerator. The AI refrigerator includes: a communication unit, a camera for photographing a tray including a plurality of grooves in each of which food is received, and a processor for controlling the communication unit and the camera. The processor: extracts, from a captured image of the tray, a marker hidden by the food among a plurality of markers attached to the plurality of grooves respectively; acquires the location identifier of the groove corresponding to the hidden marker and the entry point when the food is received in the corresponding groove; transmits the acquired location identifier and entry point to a server through the communication unit; receives, from the server, color information determined on the basis of the entry point; and performs control such that a light emitting diode disposed in the corresponding groove outputs a color to be displayed in the groove, included in the received color information.

WO 2019/041962 A1 describes a smart refrigerator-based networking and control method and system and a smart refrigerator. The smart refrigerator-based networking and control method includes: obtaining device information of the smart refrigerator; receiving device information and a network access request sent by a device requiring network access by means of a Bluetooth module; binding the device information of the device requiring network access and the device information of the smart refrigerator; generating binding information; and sending the device information of the device requiring network access, the device information of the smart refrigerator, and the binding information to a server, so that the server responds to the network access request according to the device information of the device requiring network access, the device information of the smart refrigerator, and the binding information.

U.S. Published Patent Application No. 2016/0162715 A1 and WO 2016/089440 A1 describe a smart refrigerator system. The smart refrigerator system may read a tag coupled to a food item using tag readers; determine an identity of the food item, an associated date of the food item, and/or a compartment containing the food item; track item information that includes the identity of the food item, a state of the food item, and/or a compartment location of the food item; receive item usage information indicating when a user plans to use the food item and change a temperature of the food item; and generate a notification regarding freshness and/or a spoilage level of the food item and present it to the user.

CN 102594637 B describes a refrigerator-based smart home control system. The system is arranged in an Internet of Things (IoT) refrigerator body and comprises a system master control module. The system master control module is connected to numerous components, such as a network communication module, a liquid crystal display (LCD) touch module, a WiFi module, and a refrigerator master control module.

Some similar systems exist in the art. However, their means of operation are substantially different from the present disclosure, as the other inventions fail to solve all the problems taught by the present disclosure.

### SUMMARY OF THE EMBODIMENTS

The present invention and its embodiments relate to an artificial intelligence (AI) refrigerator for use in retail.

In particular, a first embodiment of the present invention includes a system. The system includes an artificial intelligence (AI) refrigerator, a server, and a computing device. The AI refrigerator is used in retail and includes a door affixed to a body. The body of the AI refrigerator includes an exterior portion and an interior portion. The exterior portion of the AI refrigerator comprises a touchpad and a door locking feature to lock the door. The touchpad comprises a scanner. The interior portion of the AI refrigerator comprises a platform configured to hold inventory thereon and one or more cameras configured to record a quantity of each product of the inventory and a location of each product of the inventory.

The server is configured to store a list of the inventory and the location of the inventory and utilize one or more computer vision or artificial intelligence means to control the AI refrigerator. The computing device has an application executed thereon. The application is configured to display a QR code to the customer associated with a unique identification of the AI refrigerator.

The computing system of the AI refrigerator is configured to receive the QR code from the customer. Further, in response to a determination that the door has been closed for a predetermined amount of time, the one or more computer vision or artificial intelligence means of the server are configured to: utilize the one or more cameras to capture images of the inventory located within the AI refrigerator and transmit the images to the server. It should be appreciated that the one or more computer vision or artificial intelligence means of the server are configured to determine that the door of the AI refrigerator has been closed for the predetermined amount of time via one or more magnetic sensors.

Additionally, in response to the determination that the door has been closed for the predetermined amount of time, the one or more computer vision or artificial intelligence means of the server are further configured to: utilize trained weights of an AI model to detect the inventory within the AI refrigerator, determine an identification of the AI refrigerator, and use the identification of the AI refrigerator to retrieve a last inventory product identification and quantity from the server. Moreover, in response to the determination that the door has been closed for the predetermined amount of time, the one or more computer vision or artificial intelligence means of the server are further configured to: compare a current inventory within the AI refrigerator to the last inventory to determine a product missing from within the AI refrigerator.

In examples, the last inventory product identification comprises images of the product. In these examples, the comparing, by the one or more computer vision or artificial intelligence means of the server, of the current inventory within the AI refrigerator to the last inventory to determine the product missing from within the AI refrigerator comprises engaging in object similarity analysis.

In response to the determination that the door has been closed for the predetermined amount of time, the one or more computer vision or artificial intelligence means of the server are further configured to: determine a sales price for the product, post a bill for the sales price of the product to the customer, receive a payment for the sales price of the product from the customer, transmit a receipt for the transaction to the customer with a total bill cost, a transaction date, and a transaction time, save the transaction in the server, and update the inventory in the server.

In particular, a second embodiment of the present invention includes a method executed by one or more computer vision or artificial intelligence means of a server. The method includes numerous process steps, such as: receiving a scanned QR code associated with a customer and a location, unlocking a door to an AI refrigerator, and determining that the door to the AI refrigerator has been closed for a predetermined amount of time. In some examples, the one or more computer vision or artificial intelligence means of the server determine that the door of the AI refrigerator has been closed for the predetermined amount of time via one or more magnetic sensors.

In response to the determination that the door to the AI refrigerator has been closed for the predetermined amount of time, the one or more computer vision or artificial intelligence means of the server are configured to: receive images of inventory located within the AI refrigerator from one or more cameras located within the AI refrigerator, utilize trained weights of an AI model to detect the inventory within the AI refrigerator, determine an identification of the AI refrigerator, use the identification of the AI refrigerator to retrieve a last inventory product identification and quantity, and compare a current inventory within the AI refrigerator to the last inventory to determine a product missing from within the AI refrigerator. In some examples, the last inventory product identification comprises images of the product. In these examples, the comparison comprises an object similarity analysis.

Moreover, the method further includes: determining a sales price for the product, posting a bill for the sales price of the product to the customer, receiving a payment for the sales price of the product from the customer, transmitting a receipt for the transaction to the customer with a total bill cost, a transaction date, and a transaction time, saving the transaction in the server, and updating the inventory in the server.

### BRIEF DESCRIPTION OF THE DRAWINGS

FIG. 1 depicts a block diagram of a system comprising an AI refrigerator, a server, and a computing device, the system showcasing components present on a first side (e.g., a door) of the AI refrigerator, according to at least some embodiments disclosed herein.

FIG. 2 depicts a block diagram of a system comprising an AI refrigerator, a server, and a computing device, the system showcasing components present in an interior of the AI refrigerator, according to at least some embodiments disclosed herein.

FIG. 3 depicts a block diagram of a computing device used in a system, according to at least some embodiments disclosed herein.

FIG. 4 depicts process steps of a method, according to at least some embodiments disclosed herein.

### DESCRIPTION OF THE PREFERRED EMBODIMENTS

The preferred embodiments of the present invention will now be described with reference to the drawings. Identical elements in the various figures are identified with the same reference numerals. Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

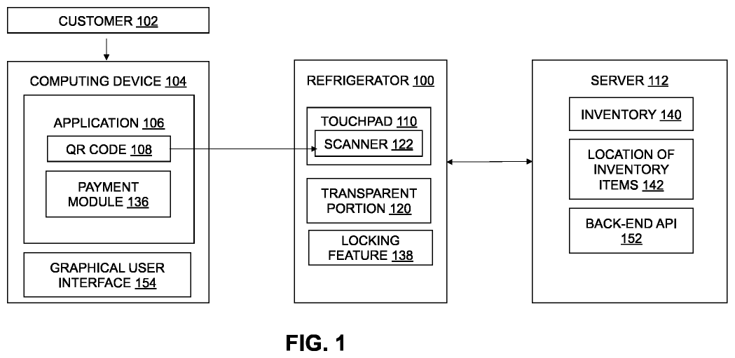

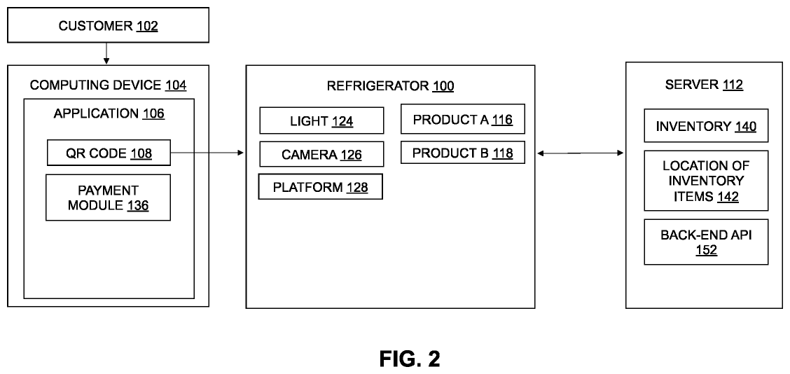

The present invention describes a system. Such system may be depicted in FIG. 1 and FIG. 2. The system of FIG. 1 and FIG. 2 includes an AI refrigerator 100 for use in retail, a server 112, and a computing device 104. It should be appreciated that FIG. 1 depicts components present on the first side (e.g., the door) of the AI refrigerator 100, whereas FIG. 2 depicts components present in an interior of the AI refrigerator 100.

Though the server 112 is described herein, the server 112 may be replaced with a database or another similar device. Further, the computing device 104 may be a computer, a laptop computer, a smartphone, and/or a tablet, among other examples not explicitly listed herein. In general, the AI refrigerator 100 includes a body. The body includes a first side disposed opposite a second side, a third side disposed opposite a fourth side, a fifth side disposed opposite a sixth side, and an interior. The first side of the body of the AI refrigerator 100 is a customer-facing side and comprises a door. Moreover, the first side of the body of the AI refrigerator 100 includes a touchpad 110 (containing a scanner 122), a door locking feature 138, and optionally one or more transparent portions 120, such that a customer 102 may view one or more food and/or drink products (e.g., a product A 116 and/or a product B 118 of FIG. 2) located within the AI refrigerator 100. The door locking feature 138 may comprise any locking feature or component known to those having ordinary skill in the art.

It should be appreciated that the typical specifications for the AI refrigerator 100 are as such and are provided for illustrative purposes only: a crated weight of up to 242 pounds, cabinet dimensions of approximately 25 inches W×23 inches D×72 inches H, a cabinet temperature of approximately 33° F. to approximately 38° F., can hold up to 100 inventory items, can be connected to the server 112 via a wired or a wireless connection, has an input voltage of approximately 96 VAC to approximately 140 VAC, has surge protection of approximately 10 AMP, has a cord length (to plug into an electrical outlet) of approximately 3 feet, and has a compliance of PCI&NSF-7.

More specifically, as shown in FIG. 2, the interior of the AI refrigerator 100 comprises one or more platforms 128 configured to hold food and/or drink inventory 140 thereon, one or more lamp/lights 124 configured to illuminate the food and/or drink inventory 140, and one or more cameras 126 configured to record a quantity of each product of the food and/or drink inventory 140 and a location 142 of each product of the food and/or drink inventory 140.

It should be appreciated that the AI refrigerator 100 may include the one or more platforms 128 stacked vertically and/or horizontally within the AI refrigerator 100. A Raspberry Pi may be located within a base of the one or more platforms 128, with the one or more cameras 126 being fixed above the one or more platform 128. It should be appreciated that, as described herein, that the Raspberry Pi is a series of small single-board computers. The Raspberry Pi used may be Raspberry Pi Zero W, in some examples. However, the Raspberry is not limited to such.

In specific examples, a quantity of the one or more cameras 126 is seven, with one of the one or more cameras 126 being located on a top shelf within the AI refrigerator 100 and with a group of the one or more cameras 126 being placed in a middle of a shelf and at extreme positions on each shelf within the AI refrigerator 100. However, it should be appreciated that this is described for illustrative purposes only and other configurations are contemplated herein. The one or more cameras 126 capture images of each item of the food and/or drink inventory 140 from multiple angles.

It should be appreciated that the server 112 of the system is configured to: store a list of the food and/or drink inventory 140 and the location 142 of the food and/or drink inventory 140 within the AI refrigerator 100. Moreover, the server 112 may store additional data and information associated with the AI refrigerator 100, such as temperature data, alarms, customer profiles, vendor profiles, menus for the food and/or drink inventory in the AI refrigerator 100, etc. In some examples, the menus may be associated with a specific vendor. For example, the server 112 may store a first menu associated with food and drink products from Jane's Bakery and may store a second menu associated with food and drink products from Tim's Pub. The server 112 may also store over 100 images per item in the inventory 140 in different lighting conditions and locations within the AI refrigerator 100. In more specific examples, the server 112 may also store approximately 150 images per item in the inventory 140 in different lighting conditions and locations within the AI refrigerator 100.

Additionally, the server 112 is configured to: utilize one or more computer vision or artificial intelligence means or algorithms to control the AI refrigerator 100. It should be appreciated that training may occur for the one or more computer vision or artificial intelligence means. Further, the system utilizes Python, which runs on the server 112 to get and send MQTT messages to the AI refrigerator 100. It should be appreciated that MQTT is an open OASIS and ISO standard lightweight, publish-subscribe network protocol that transports messages between devices. The protocol usually runs over TCP/IP; however, any network protocol that provides ordered, lossless, bi-directional connections can support MQTT. It should be appreciated that MQTT may be replaced with a similar message broker.

Also, PHP, a scripting language, may be used in this system to display data on dashboards, provide authentications, etc. Moreover, Tensorflow Object Detection API provided by Google may be used for deep learning and object/inventory detection. This API is in Python. Moreover, OpenCV may be used to make the detections run in only specific parts of the frame captured by the one or more cameras 126. For example, if there is an overlap of view area between a first camera of the one or more cameras 126 and a second camera of the one or more cameras 126, OpenCV may ensure that the first camera covers only a left side of the view area and the second camera covers only a right side of the view area.

Moreover, it should be appreciated that the Raspberry Pi and Python also serve to send images of the food and/or drink inventory 140 from the one or more cameras 126 to the server 112. Such images may be received by the server 112 in regular intervals (e.g., ever second, every minute, etc.). The server 112 may then process the images from different angles and will take a mean for each object of the food and/or drink inventory 140. For example, if a first camera of the one or more cameras 126 counts 10 milk boxes and a second camera of the one or more cameras 126 counts 14 milk boxes, then the server 112 will identify that there are 12 milk boxes (e.g., the mean of 10 milk boxes and 14 milk boxes). In another example, if the first camera of the one or more cameras 126 counts 10 milk boxes and the second camera of the one or more cameras 126 counts 11 milk boxes, then the server 112 may identify that there are 11 milk boxes. As such, it should be appreciated that there are different inventory object instances detected for each of the one or more cameras 126, as all of them are at different angles.

Additionally, the server 112 may include a back-end API 152 as shown in FIG. 1 and FIG. 2. The back-end API 152 is responsible for all the backend services of the system, such as refrigerator services, product services, refrigerator inventory services, transaction services, administrative services, feedback services, etc. The back-end API 152 was developed using .NET Core 3.1.

Additionally, as shown in FIG. 1 and FIG. 2, the computing device 104 of the system has an application 106 executed thereon. In other examples, the application 106 may be an engine, a software program, or a service configured to be executable on the computing device 104. The customer 102 may interact with the application 106 of the computing device 104 via a graphical user interface (GUI) 154 of the computing device 104. Numerous API services may be used in the application 106, such as a customer API, a feedback API, a refrigerator API, a user API, a MQTT API, and/or a product API, among others. It should be appreciated that, as described herein, MQTT is a machine-to-machine (M2M)/“Internet of Things or IoT” connectivity protocol. More specifically, MQTT is an OASIS standard messaging protocol for the IoT. It should be appreciated that MQTT may be replaced with a similar message broker.

The application 106 is configured to display a QR code 108 to the customer 102. The QR code 108 may be associated with a unique identification of the specific AI refrigerator 100. More specifically, the QR code 108 may include contact data of an administrator/operator of the AI refrigerator 100, an email address of the administrator/operator of the AI refrigerator 100, a phone number of the administrator/operator of the AI refrigerator 100, SMS data, and geolocation data of AI refrigerator 100.

Moreover, the scanner 122 is configured to receive (e.g., scan) the QR code 108 from the customer 102. Next, the one or more computer vision or artificial intelligence means of the server 112 are configured to: confirm the unique identification of the AI refrigerator 100 from the QR code 108, present a menu of the food and/or drink inventory 140 located within the AI refrigerator 100 to the customer 102 via the computing device 104, receive a selection a product from the menu of the food and/or drink inventory 140 from the customer 102, open the door (e.g., the first side) of the AI refrigerator 100, detect a closing of the door by the customer 102, and utilize the door locking feature 138 to lock the door to ensure the food and/or drink inventory 140 is not stolen.

Additionally, the one or more computer vision or artificial intelligence means or algorithms of the server 112 are configured to: detect, using the camera 126, one or more inventory items missing from the food and/or drink inventory 140, update the list of the food and/or drink inventory 140 and the location of the food and/or drink inventory 140, and prompt the customer 102 to pay for the one or more items missing from the food and/or drink inventory 140 via a payment module 136 of the application 106 on the computing device 104. Payment may be processed by any conventional means known to those having ordinary skill in the art. In some examples, a customer account associated with a customer profile may be automatically charged for the item the customer 102 obtained from the AI refrigerator 100 and the customer may receive a receipt via an email address associated with the customer account. Moreover, the customer 102 may also provide feedback on their experience with the AI refrigerator 100 via the application 106 on the computing device 104. Such feedback may be used to update/modify the system described herein.

Depending on the implementation, the images obtained from the one or more cameras 126 are processed either on the server 112 or locally on the AI refrigerator 100, using the computer vision/artificial intelligence methods, means, or algorithms.

An administrator controls which individuals and which groups of individuals are able to create a profile and interact with the system described herein. If a vendor is authorized to create such profile, for example, the vendor may interact with the system via a vendor interface on another computing device to see where their products are and what AI refrigerators their products are located in.

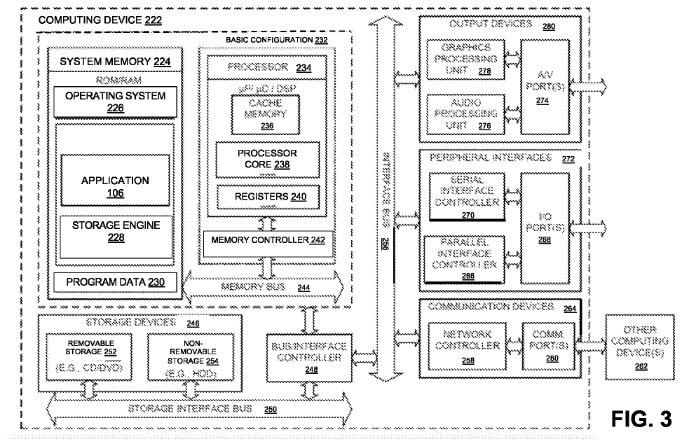

FIG. 3 is a block diagram of a computing device included within a computer system of the instant invention. In some embodiments, the present invention may be a computer system, a method, and/or the computing device 104 (of FIG. 1 and FIG. 2) or the computing device 222 (of FIG. 3). For example, the computer system and/or the computing device 222 may be utilized to implement the method described herein.

A basic configuration 232 of a computing device 222 is illustrated in FIG. 3 by those components within the inner dashed line. In the basic configuration 232 of the computing device 222, the computing device 222 includes a processor 234 and a system memory 224. In some examples, the computing device 222 may include one or more processors and the system memory 224. A memory bus 244 is used for communicating between the one or more processors 234 and the system memory 224.

Depending on the desired configuration, the processor 234 may be of any type, including, but not limited to, a microprocessor (μP), a microcontroller (μC), and a digital signal processor (DSP), or any combination thereof. Further, the processor 234 may include one more levels of caching, such as a level cache memory 236, a processor core 238, and registers 240, among other examples. The processor core 238 may include an arithmetic logic unit (ALU), a floating point unit (FPU), and/or a digital signal processing core (DSP Core), or any combination thereof. A memory controller 242 may be used with the processor 234, or, in some implementations, the memory controller 242 may be an internal part of the memory controller 242.

Depending on the desired configuration, the system memory 224 may be of any type, including, but not limited to, volatile memory (such as RAM), and/or non-volatile memory (such as ROM, flash memory, etc.), or any combination thereof. The system memory 224 includes an operating system 226, one or more engines, such as the application 106, and program data 230. In some embodiments, the application 106 may be a software program, a service, or a software platform, as described infra. The system memory 224 may also include a storage engine 228 that may store any information disclosed herein.

Moreover, the computing device 222 may have additional features or functionality, and additional interfaces to facilitate communications between the basic configuration 232 and any desired devices and interfaces. For example, a bus/interface controller 248 is used to facilitate communications between the basic configuration 232 and data storage devices 246 via a storage interface bus 250. The data storage devices 246 may be one or more removable storage devices 252, one or more non-removable storage devices 254, or a combination thereof. Examples of the one or more removable storage devices 252 and the one or more non-removable storage devices 254 include magnetic disk devices (such as flexible disk drives and hard-disk drives (HDD)), optical disk drives (such as compact disk (CD) drives or digital versatile disk (DVD) drives), solid state drives (SSD), and tape drives, among others.

In some embodiments, an interface bus 256 facilitates communication from various interface devices (e.g., one or more output devices 280, one or more peripheral interfaces 272, and one or more communication devices 264) to the basic configuration 232 via the bus/interface controller 256. Some of the one or more output devices 280 include a graphics processing unit 278 and an audio processing unit 276, which are configured to communicate to various external devices, such as a display or speakers, via one or more A/V ports 274.

The one or more peripheral interfaces 272 may include a serial interface controller 270 or a parallel interface controller 266, which are configured to communicate with external devices, such as input devices (e.g., a keyboard, a mouse, a pen, a voice input device, or a touch input device, etc.) or other peripheral devices (e.g., a printer or a scanner, etc.) via one or more I/O ports 268.

Further, the one or more communication devices 264 may include a network controller 258, which is arranged to facilitate communication with one or more other computing devices 262 over a network communication link via one or more communication ports 260. The one or more other computing devices 262 include servers, the database, mobile devices, and comparable devices.

The network communication link is an example of a communication media. The communication media are typically embodied by the computer-readable instructions, data structures, program modules, or other data in a modulated data signal, such as a carrier wave or other transport mechanism, and include any information delivery media. A “modulated data signal” is a signal that has one or more of its characteristics set or changed in such a manner as to encode information in the signal. By way of example, and not limitation, the communication media may include wired media (such as a wired network or direct-wired connection) and wireless media (such as acoustic, radio frequency (RF), microwave, infrared (IR), and other wireless media). The term “computer-readable media,” as used herein, includes both storage media and communication media.

It should be appreciated that the system memory 224, the one or more removable storage devices 252, and the one or more non-removable storage devices 254 are examples of the computer-readable storage media. The computer-readable storage media is a tangible device that can retain and store instructions (e.g., program code) for use by an instruction execution device (e.g., the computing device 222). Any such, computer storage media is part of the computing device 222.

The computer readable storage media/medium can be a tangible device that can retain and store instructions for use by an instruction execution device. The computer readable storage media/medium may be, for example, but is not limited to, an electronic storage device, a magnetic storage device, an optical storage device, an electromagnetic storage device, and/or a semiconductor storage device, or any suitable combination of the foregoing. A non-exhaustive list of more specific examples of the computer readable storage media/medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and/or a mechanically encoded device (such as punch-cards or raised structures in a groove having instructions recorded thereon), and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present invention are described herein regarding illustrations and/or block diagrams of methods, computer systems, and computing devices according to embodiments of the invention. It will be understood that each block in the block diagrams, and combinations of the blocks, can be implemented by the computer-readable instructions (e.g., the program code).

The computer-readable instructions are provided to the processor 234 of a general purpose computer, special purpose computer, or other programmable data processing apparatus (e.g., the computing device 222) to produce a machine, such that the instructions, which execute via the processor 234 of the computer or other programmable data processing apparatus, create means for implementing the functions/acts specified in the block diagram blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions, which implement aspects of the functions/acts specified in the block diagram blocks.

The computer-readable instructions (e.g., the program code) are also loaded onto a computer (e.g. the computing device 222), another programmable data processing apparatus, or another device to cause a series of operational steps to be performed on the computer, the other programmable apparatus, or the other device to produce a computer implemented process, such that the instructions, which execute on the computer, the other programmable apparatus, or the other device, implement the functions/acts specified in the block diagram blocks.

Computer readable program instructions described herein can also be downloaded to respective computing/processing devices from a computer readable storage medium or to an external computer or external storage device via a network (e.g., the Internet, a local area network, a wide area network, and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer/computing device, partly on the user's computer/computing device, as a stand-alone software package, partly on the user's computer/computing device and partly on a remote computer/computing device or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

Another embodiment of the invention provides a method that performs the process steps on a subscription, advertising, and/or fee basis. That is, a service provider can offer to assist in the method steps described herein. In this case, the service provider can create, maintain, and/or support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

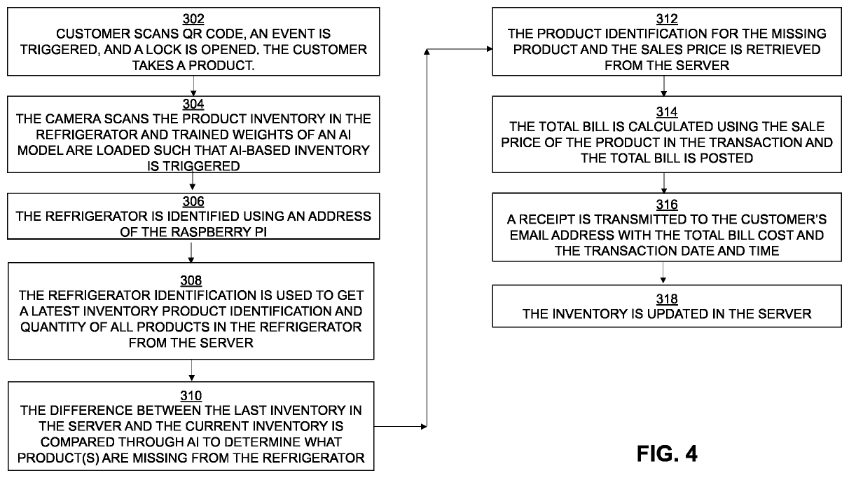

Further, a method is depicted in FIG. 4. The method of FIG. 4 begins at a process step 302, where the customer 102 scans the QR code 108 on the AI refrigerator 100 and an event is triggered. Specifically, upon the scan of the QR code 108, a message is received by the AI refrigerator 100 via MQTT and the AI refrigerator 100 issues or triggers a command to the locking feature 138 to unlock a door of the AI refrigerator 100. It should be appreciated that MQTT may be replaced with a similar message broker. At this process step 302, the AI refrigerator 100 lock is opened via the locking feature 138 and the customer 102 takes one or more products (e.g., the product A 116 and/or the product B 118) from the AI refrigerator 100.

Further, a door status of the AI refrigerator 100 is checked after approximately 10 seconds. If the door to the AI refrigerator 100 has been closed after the customer 102 took the one or more products (e.g., the product A 116 and/or the product B 118) from the AI refrigerator 100 and left, then the AI refrigerator 100 senses it via one or more magnetic sensors and uses serial communication to confirm a closed status of the door of the AI refrigerator 100. When that happens, temperature and humidity readings are taken for the AI refrigerator 100 and they are transmitted to an administrator interface of the application 106. These readings may also be saved in the server 112.

A process step 304 follows the process step 302 and includes the one or more cameras 126 scanning the product inventory 140 located within the AI refrigerator 100. In some examples, FFmpeg is used to capture the images of the product inventory 140 located within the AI refrigerator 100. It should be appreciated that “FFmpeg” is a free and open-source software project consisting of a suite of libraries and programs for handling video, audio, and other multimedia files and streams. At its core is the command-line FFmpeg tool itself, designed for processing of video and audio files. The captured images from the one or more cameras 126 are then saved in the server 112. Further, at the process step 304, trained weights of an AI model from the server 112 are used to run inference on the images from the one or more cameras 126 to detect the product inventory 140 located within the AI refrigerator 100.

A process step 306 follows the process step 304 and includes identifying the AI refrigerator 100 using an address of the Raspberry Pi.

A process step 308 follows the process step 306 and includes using the refrigerator identification to receive a last inventory product identification and quantity of all products in the AI refrigerator 100 from the server 112. In some examples, the inventory 140 saved in the server 112 includes the location of the inventory items 142, an identification of the inventory 140, a quantity of the inventory 140, and images of the inventory 140.

A process step 310 follows the process step 308 and includes comparing a difference between the last inventory in the server 112 and the current inventory within the AI refrigerator 100 through the AI to determine what products are missing from the AI refrigerator 100 (e.g., which products the customer 102 took from the AI refrigerator 100). In an example, this process step may include comparing images taken by the one or more cameras 126 between the last inventory in the server 112 and the current inventory within the AI refrigerator 100 through the AI to determine what products are missing from the AI refrigerator 100.

In examples, this process step may include engaging in object similarity analysis using one or more algorithms. In an illustrative example, the inventory 140 captured by the one or more cameras 126 may be divided into categories based on the shapes of the products. For example, the categories may include: salads (e.g., having a square packaging), burritos (e.g., having a cylindrical shape when wrapped), cut sandwiches (e.g., having a triangular shape when packaged), drinks (e.g., having a cylindrical shape), etc. At this process step, the difference between a category of the last inventory in the server 112 and a category of the current inventory within the AI refrigerator 100 may be compared through the AI to determine what products are missing from the AI refrigerator 100.

If the difference between the last inventory in the server 112 and the current inventory within the AI refrigerator 100 is 0, then the process is terminated, since it is determined that the customer 102 did not take any products from the AI refrigerator 100.

If the difference between the last inventory in the server 112 and the current inventory within the AI refrigerator 100 is non-zero and the customer 102 took one or more products from the AI refrigerator 100, the process step 310 moves onto a process step 312.

At the process step 312, an identification of the products taken by the customer 102 from the AI refrigerator 100 is determined, as well as a sales price for the products. A process step 314 follows the process step 312 and includes calculating a total bill using the sale price of the products in the transaction. The process step 314 also includes posting the total bill for the products to the customer 102.

A process step 316 follows the process step 314 and includes transmitting a receipt for the transaction to the customer 102 with the total bill cost and the transaction date and time. The customer 102 may receive this receipt via email, text message, or another means known to those having skill in the art.

Lastly, a process step 318 follows the process step 316 and includes saving the transaction and updating the inventory 140 in the server 112. The process step 318 concludes the method of FIG. 4.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A system comprising:
an artificial intelligence (AI) refrigerator for use in retail, the AI refrigerator comprising:
a door affixed to a body, the body comprising an exterior portion and an interior portion,
wherein the exterior portion comprises a touchpad and a door locking feature to lock the door,
wherein the touchpad comprises a scanner, and
wherein the interior portion comprises a platform configured to hold inventory thereon and one or more cameras configured to record a quantity of each product of the inventory and a location of each product of the inventory;
a server configured to:
store a list of the inventory and the location of the inventory; and
utilize one or more computer vision or artificial intelligence means to control the AI refrigerator; and
a computing device having an application executed thereon, wherein the application is configured to display a QR code to the customer associated with a unique identification of the AI refrigerator.

2. The system of claim 1, wherein the scanner is configured to receive the QR code from the customer.

3. The system of claim 2, wherein the one or more computer vision or artificial intelligence means of the server are further configured to:
unlock the door; and
in response to a determination that the door has been closed for a predetermined amount of time,
utilize the one or more cameras to capture images of the inventory located within the AI refrigerator; and
transmit the images to the server.

4. The system of claim 3, wherein the one or more computer vision or artificial intelligence means of the server determine that the door of the AI refrigerator has been closed for the predetermined amount of time via one or more magnetic sensors.

5. The system of claim 3, wherein the one or more computer vision or artificial intelligence means of the server are further configured to:
utilize trained weights of an AI model to detect the inventory within the AI refrigerator;
determine an identification of the AI refrigerator; and
use the identification of the AI refrigerator to retrieve a last inventory product identification and quantity from the server.

6. The system of claim 5, wherein the one or more computer vision or artificial intelligence means of the server are further configured to compare a current inventory within the AI refrigerator to the last inventory to determine a product missing from within the AI refrigerator.

7. The system of claim 5, wherein the last inventory product identification comprises images of the product.

8. The system of claim 7, wherein the comparing, by the one or more computer vision or artificial intelligence means of the server, of the current inventory within the AI refrigerator to the last inventory to determine the product missing from within the AI refrigerator comprises engaging in object similarity analysis.

9. The system of claim 6, wherein the one or more computer vision or artificial intelligence means of the server are further configured to:
determine a sales price for the product; and
post a bill for the sales price of the product to the customer.

10. The system of claim 9, wherein the one or more computer vision or artificial intelligence means of the server are further configured to:
receive a payment for the sales price of the product from the customer; and
transmit a receipt for the transaction to the customer with a total bill cost, a transaction date, and a transaction time.

11. The system of claim 10, wherein the one or more computer vision or artificial intelligence means of the server are further configured to:
save the transaction in the server; and
update the inventory in the server.

12. A method executed by one or more computer vision or artificial intelligence means of a server, the method comprising:
receiving a scanned QR code associated with a refrigerator;
unlock a door to an artificial intelligence (AI) refrigerator used in retail; and
in response to a determination that the door to the AI refrigerator has been closed for a predetermined amount of time,
receive images of inventory located within the AI refrigerator from one or more cameras located within the AI refrigerator;
utilize trained weights of an AI model to detect the inventory within the AI refrigerator;
determine an identification of the AI refrigerator;
use the identification of the AI refrigerator to retrieve a last inventory product identification and quantity;
compare a current inventory within the AI refrigerator to the last inventory to determine a product missing from within the AI refrigerator;
determine a sales price for the product; and
post a bill for the sales price of the product to the customer.

13. The method of claim 12, wherein the one or more computer vision or artificial intelligence means of the server determine that the door of the AI refrigerator has been closed for the predetermined amount of time via one or more magnetic sensors.

14. The method of claim 12, wherein the last inventory product identification comprises images of the product.

15. The method of claim 14, wherein the comparing, by the one or more computer vision or artificial intelligence means of the server, of the current inventory within the AI refrigerator to the last inventory to determine the product missing from within the AI refrigerator comprises engaging in object similarity analysis.

16. The method of claim 12, further comprising:
receiving a payment for the sales price of the product from the customer; and
transmitting a receipt for the transaction to the customer with a total bill cost, a transaction date, and a transaction time.

17. The method of claim 16, further comprising:
saving the transaction in the server; and
updating the inventory in the server.
